(19) United States
(12) Patent Application Publication
(10) Pub. No.: US 2006/0212513 A1
(43) Pub. Date: Sep. 21, 2006

(54) Managing apparatus, managing method and computer-readable storage medium

(75) Inventor: Yoshiyuki Inage, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/362,428

(22) Filed: Feb. 27, 2006

Related U.S. Application Data
(63) Continuation of application No. PCT/JP03/13802, filed on Oct. 28, 2003.

(51) Int. Cl. G06F 15/16

(52) U.S. Cl. 709/203

(57) ABSTRACT

A managing apparatus is provided with a first part to transfer data requested by an information processing apparatus to the information processing apparatus, a second part to determine a start date when use of the data is started, based on start date and time information indicating a date and time when the data became usable in the information processing apparatus, and a third part to determine an end date when the use of the data is ended, based on end date and time information indicating a date and time when the data became non-usable in the information processing apparatus.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2003/013802 filed Oct. 28, 2003, in the Japanese Patent Office, the disclosure of which is hereby incorporated by reference.

### BACKGROUND OF THE INVENTION

1. Field of the Invention

The present invention generally relates to managing apparatuses, managing methods and computer-readable storage media, and more particularly to a managing apparatus and a managing method which provide information such as software in response to a request from a user. The present invention also more particularly relates to a managing program (computer program) for causing a computer to provide information by such a managing method, and to a computer-readable storage medium which stores such a managing program (computer program).

2. Description of the Related Art

When a user rents software such as a computer program, there is a conventional method that transfers the software, with limited usable time period, from a server to a personal computer or the like of the user via a network such as the Internet. In this case, the software that is transferred from the server to the personal computer of the user is automatically deleted after the rental period ends or, is forcibly made inoperative by a protection function after the rental period ends, in order to prevent unauthorized use of the software after the rental period ends.

However, according to the conventional method, the software that is transferred from the server to the personal computer of the user is automatically deleted after the rental period ends or, is forcibly made inoperative by the protection function after the rental period ends. For this reason, if the user forgets the rental period and continues to use the rented software, for example, there was a problem in that the software may become non-usable together with the data in use by the software while the user is operating the personal computer.

In addition, according to the conventional method, there was a problem in that the rental period cannot be extended in a simple manner.

Furthermore, since the software that is downloaded from the server to the personal computer of the user is automatically deleted after the rental period ends or, is forcible made inoperative by the protection function after the rental period ends, the information stored in the personal computer is automatically rewritten or deleted when the rental period ends. The user cannot intervene in such automatic rewriting or deleting of the information stored in the personal computer. However, when the information stored in the personal computer is automatically rewritten or deleted, there was a problem in that the information which should not be rewritten or deleted may be erroneously rewritten or deleted particularly when accompanied by an access from an external server, to thereby interfere with the operation of the personal computer.

### SUMMARY OF THE INVENTION

Accordingly, it is a general object of the present invention to provide a novel and useful managing apparatus, managing method, managing program and computer-readable storage medium, in which the problems described above are suppressed.

Another and more specific object of the present invention is to provide a managing apparatus, a managing method, a managing program and a computer-readable storage medium, which can end the use of rented software in a user-led manner, so that the software will not become non-usable together with the data in use by the software while the user is making an operation using the software.

Still another object of the present invention is to provide a managing apparatus comprising a first part configured to transfer data requested by an information processing apparatus to the information processing apparatus; a second part configured to determine a start date when use of the data is started, based on start date and time information indicating a date and time when the data became usable in the information processing apparatus; and a third part configured to determine an end date when the use of the data is ended, based on end date and time information indicating a date and time when the data became non-usable in the information processing apparatus. According to the managing apparatus of the present invention, it is possible to end the use of rented data such as software in a user-led manner, so that the software will not become non-usable together with the data in use by the software while the user is making an operation using the software.

A further object of the present invention is to provide a managing method comprising a first step transferring data requested by an information processing apparatus to the information processing apparatus; a second step determining a start date when use of the data is started, based on start date and time information indicating a date and time when the data became usable in the information processing apparatus; and a third step determining an end date when the use of the data is ended, based on end date and time information indicating a date and time when the data became non-usable in the information processing apparatus. According to the managing method of the present invention, it is possible to end the use of rented data such as software in a user-led manner, so that the software will not become non-usable together with the data in use by the software while the user is making an operation using the software.

Another object of the present invention is to provide a computer-readable storage medium which stores a managing program for causing a computer to carry out a management, the managing program comprising a first procedure causing the computer to transfer data requested by an information processing apparatus to the information processing apparatus; a second procedure causing the computer to determine a start date when use of the data is started, based on start date and time information indicating a date and time when the data became usable in the information processing apparatus; and a third procedure causing the computer to determine an end date when the use of the data is ended, based on end date and time information indicating a date and time when the data became non-usable in the information processing apparatus. According to the computer-readable storage medium of the present invention, it is possible to end the use of rented data such as software in a user-led manner, so that the software will not become non-usable together with the data in use by the software while the user is making an operation using the software.

Still another object of the present invention is to provide a managing method comprising a step opening a file by starting a viewer software corresponding to the file, depending on a selection of the file and a selection of the viewer software from a user terminal made on a Web page provided by a Web server, and a step displaying the opened file on the Web page in a state referable from the user terminal. According to the managing method of the present invention, it is possible to refer to the file that is opened on the Web page, even if the user does not possess the viewer software that is necessary to open the file.

Other objects and further features of the present invention will be apparent from the following detailed description when read in conjunction with the accompanying drawings.

### BRIEF DESCRIPTION OF THE DRAWINGS

FIG. 1 is a diagram showing a communication system to which the present invention may be applied;

FIG. 2 is a flow chart for explaining a software rental time confirming process;

FIG. 3 is a flow chart for explaining a software selecting process;

FIG. 4 is a flow chart for explaining a license key issuing process;

FIG. 5 is a flow chart for explaining a license key creating process;

FIG. 6 is a flow chart for explaining a software installing process;

FIG. 7 is a flow chart for explaining a software uninstalling process;

FIG. 8 is a flow chart for explaining a software rental ending process; and

FIG. 9 is a flow chart for explaining a viewer function.

### DESCRIPTION OF THE PREFERRED EMBODIMENTS

A description will be given of embodiments of a managing apparatus, a managing method, a managing program and a computer-readable storage medium according to the present invention, by referring to the drawing.

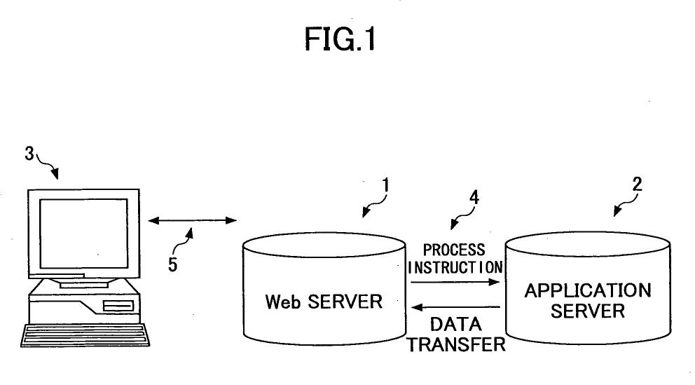

FIG. 1 is a diagram showing a communication system to which the present invention may be applied. The communication system shown in FIG. 1 includes a Web server 1, an application server 2, and a personal computer 3 that is used as a user terminal. The Web server 1 and the application server 2 are connected via a network 4. In addition, the Web server 1 and the personal computer 3 are connected by the Internet 5, by a broadband connection, for example. Each of the Web server 1 and the application server 2 may be realized by a general-purpose computer having a known basic structure that includes a CPU, a memory and the like. The personal computer 3 may also be realized by a general-purpose computer having a known basic structure including a CPU, a memory, an input device, a display part and the like. The Web server 1 may of course be constructed to include the functions of the application server 2, and in this case, the Web server 1 will include a database and the application server 2 may be omitted.

The Web server 1 has the functions of providing one or a plurality of Web pages, and displaying an instruction menu for each operation item on a browser of the personal computer 3 in response to a request from the personal computer 3 that requests a Web page by the browser. The application server 2 has a database for each operation item, and in this embodiment, has at least a database of rental software. The rental software includes programs, games and the like. When an instruction is input on the instruction menu that is displayed on the browser of the personal computer 3, the Web server 1 starts an application, within the application server 2, corresponding to the input instruction, and acquires data from the database corresponding to the started application. The acquired data are transferred from the Web server 1 to the personal computer 3.

As will be described later, when renting a desired software from the Web page that is accessed by the browser of the personal computer 3, the Web server 1 acquires the desired software that is requested by the personal computer 3 from the application server 2, and transfers the desired software to the personal computer 3. On the other hand, when inspecting a desired file from the Web page that is accessed by the browser of the personal computer 3, the Web server 1 acquires from the application server 2 a viewer software that is required to open the desired file that is requested by the personal computer 3, and transfers the desired file to the personal computer 3 after opening this desired file in the Web server 1.

A first embodiment of the managing apparatus according to the present invention is formed by the Web server 1, and employs a first embodiment of the managing method according to the present invention. A first embodiment of the managing program according to the present invention is executed by the Web server 1, and may be stored in a first embodiment of the computer-readable storage medium according to the present invention. The computer-readable storage medium is not limited to a particular type of recording medium, and may be formed by any recording media capable storing a computer program in a computer-readable manner, such as magnetic recording media, optical recording media, magneto-optical recording media and semiconductor memory devices.

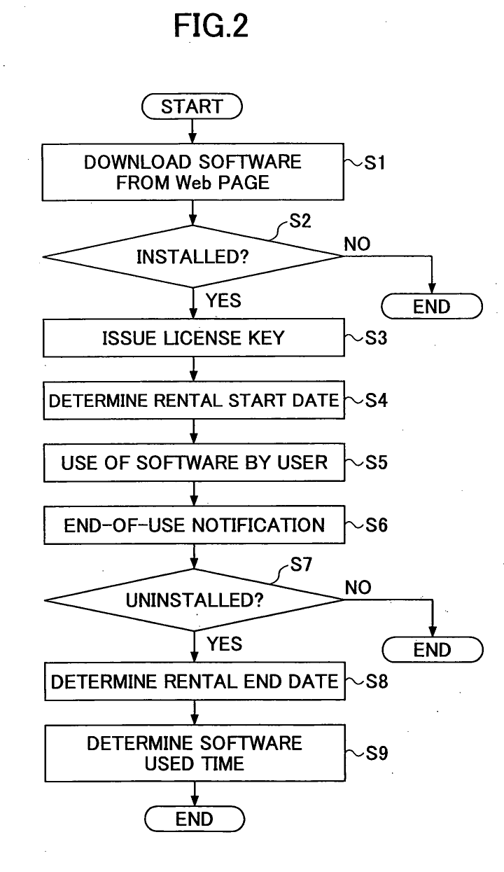

FIG. 2 is a flow chart for explaining a software rental time confirming process. In the software rental time confirming process shown in FIG. 2, steps S1 through S4 and steps S7 through S8 are carried out by the Web server 1, and steps S5 and S6 are carried out by the personal computer 3.

The software rental time confirming process shown in FIG. 2 is started when an access is made to a Web page that is provided by the Web server 1 from the browser of the personal computer 3. The step S1 displays on the personal computer 3 a list of software rentable on the accessed Web page, and when the user selects a desired software to be rented from the list of software, the desired software selected from the personal computer 3 is acquired from the database within the application server 2 and is downloaded to the personal computer 3, to thereby urge the user of the personal computer 3 to install the desired software. The software is not limited to a particular type, and in this embodiment, the software is a computer program such as an application program. The step S2 decides whether or not the desired software is installed in the personal computer 3, and the process ends if the decision result in the step S2 is NO. When the desired software is installed in the personal computer 3, install information is written in a registry of the personal computer 3, and the Web server 1 can judge whether or not the desired software has been installed in the personal computer 3 by referring to the registry of the personal computer 3.

On the other hand, if the decision result in the step S2 is YES, the step S3 issues a license key which permits the use of the desired software with respect to the personal computer 3. The step S4 determines a date and time when the license key is issued as a date when the use of the desired software is started, that is, as a rental start date.

In the step S5, the user uses the license key to use the desired software that is installed in the personal computer 3. In the step S6, the user notifies the end of use of the desired software from the personal computer 3 to the Web server 1.

The step S7 decides whether or not the desired software has been uninstalled from the personal computer 3, and the process ends if the decision result in the step S7 is NO. On the other hand, if the decision result in the step S7 is YES, the step S8 determines a date and time when the uninstalling of the desired software from the personal computer 3 is confirmed as a date when the use of the desired software is ended, that is, a rental end date. In addition, the step S9 determines a time period of use (hereinafter simply referred to as a used time) of the desired software from the rental start date and the rental end date of the desired software, and the process ends.

By determining the used time of the desired software, it is possible to carry out an accounting process with respect to the user. The accounting process itself is known, and a detailed description thereof will be omitted. For example, in a case where a rental fare for the desired software is determined in units of time, a rental fee corresponding to the used time of the desired software is charged to the user. The user may pay the rental fee by credit cards or the like or, make a remittance later. In addition, in a case where a user's account for automatic transfer is registered in the Web server 1, the rental fee may be automatically transferred from the registered account. Accordingly, the accounting process usable in this embodiment is not limited to a particular type.

In this embodiment, no particular rental time is set when the desired software is rented. For this reason, the user may use the desired software in the user-led manner for the using time desired by the examiner, without having to extend the rental time. In other words, the using time of the desired software is essentially extended unless the desired software is uninstalled from the personal computer 3.

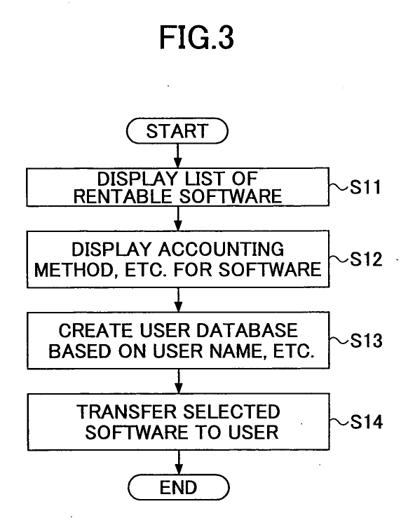

FIG. 3 is a flow chart for explaining a software selecting process, and shows the process of the step S1 shown in FIG. 2 in more detail. In FIG. 3, when the Web page provided by the Web server 1 is accessed from the browser of the personal computer 3, a step S11 displays on the personal computer 3 the list of software rentable on the accessed Web page. A step S12 displays on the personal computer 3 an accounting method, method of payment and the like for the desired software that is selected by the user on the personal computer 3. A step S13 creates a user database related to the software rental for this user, based on a user name, a credit card number and the like that are input by the user from the personal computer 3. In this case, the user database that is created includes data related to the rental of the desired software. A step S14 starts an application within the application server 2, corresponding to the desired software, acquires the desired software (data) from the database corresponding to the started application, and transfers the desired software that is acquired from the Web server 1 to the personal computer. The process ends after the step S14. A method of transferring the desired software from the Web server 1 to the personal computer 3 is not limited to a particular method, and for example, it is possible to employ an FTP transfer.

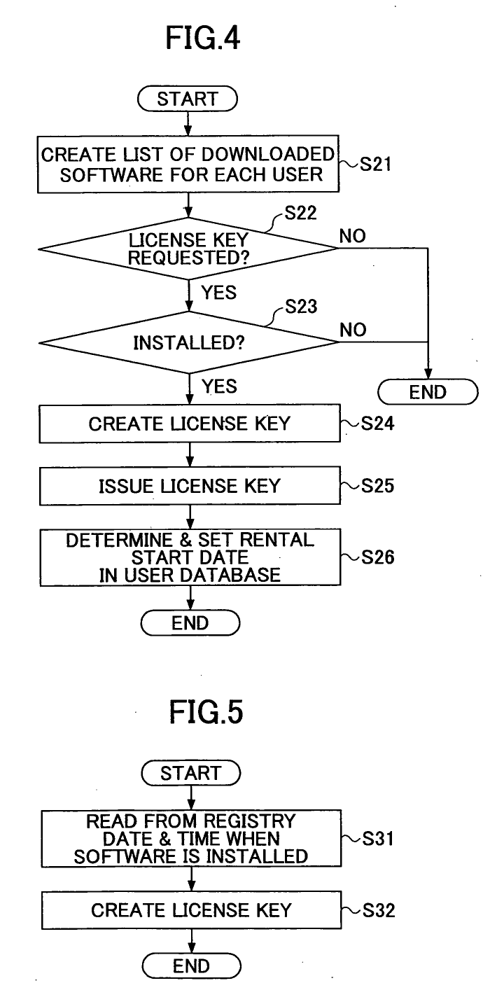

FIG. 4 is a flow chart for explaining a license key issuing process, and shows the process of the steps S2 through S4 shown in FIG. 2 in more detail. In FIG. 4, a step S21 creates a list of software downloaded to the user (hereinafter simply referred to as a list of downloaded software) with respect to each user, by referring to the user database stored in the Web serve 1. This list of downloaded software includes whether or not a license key with respect to each software is requested, an installed state (state of the registry) and the like. A step S22 refers to the list of downloaded software with respect to the user of the personal computer 3, and decides whether or not the license key with respect to the desired software is requested. The process ends if the decision result in the step S22 is NO. If the decision result in the step S22 is YES, a step S23 refers to the list of downloaded software with respect to the user of the personal computer 3, and decides whether or not the desired software is installed (that is, in the installed state) in the personal computer 3. The process ends if the decision result in the step S23 is NO.

On the other hand, if the decision result in the step S23 is YES, a step S24 creates the license key which permits the use of the desired software. A step S25 issues the created license key with respect to the personal computer 3. A step S26 determines the date and time when the license key is issued as the date when the use of the desired software is started, that is, as the rental start date, and sets the rental start date into the user database with respect to this user. The process ends after the step S26.

FIG. 5 is a flow chart for explaining a license key creating process, and shows the process of the step S3 shown in FIG. 2 and the process of the steps S24 and S25 shown in FIG. 4 in more detail. In FIG. 5, a step S31 refers to the registry of the personal computer 3, and reads date and time information indicating the date and time when the desired software is installed in the personal computer 3, from the install information with respect to the desired software. A step S32 carries out a predetermined process with respect to the date and time information indicating the date and time when the desired software is installed in the personal computer 3, so as to create the license key which permits the use of the desired software, and the process ends. The predetermined process that is carried out with respect to the date and time information indicating the date and time when the desired software is installed in the personal computer 3 is not limited to a particular process. For example, the predetermined process may be an operation process such as a multiplication with a constant coefficient or, an enciphering process.

By issuing the license key only with respect to a legitimate user, it is possible to prevent unauthorized use of the software. In other words, even if the desired software that is installed in the personal computer 3 is copied and installed in another computer, it is virtually impossible for the date and time information of the install information that is written in the registry of this other computer to perfectly match the date and time information of the install information that is written in the registry of the personal computer 3. For this reason, even if an attempt is made to use the desired software on this other computer using the license key that is issued with respect to the personal computer 3, the desired software will not be usable on this other computer.

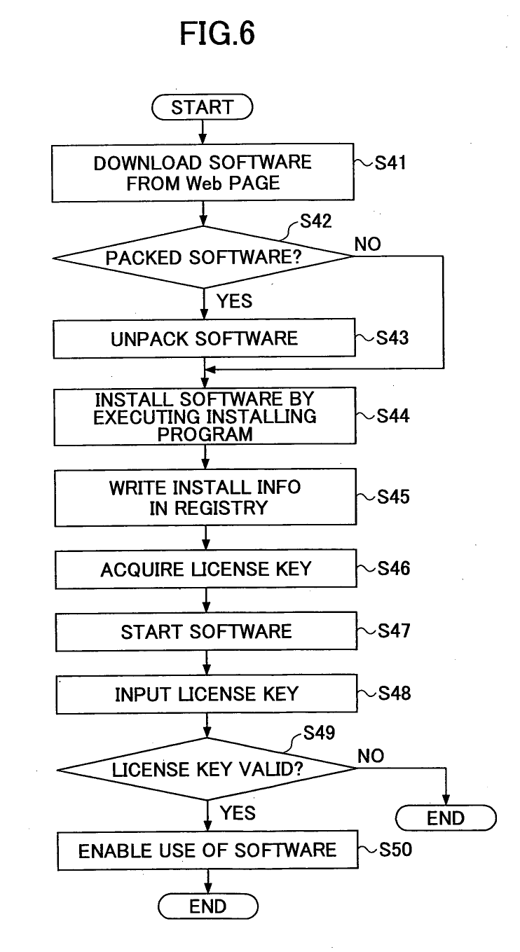

FIG. 6 is a flow chart for explaining a software installing process of the personal computer 3. In FIG. 6, a step S41 downloads the selected desired software from the Web server 1. A step S42 decides whether or not the desired software that is downloaded is packed (or compressed). The process advances to a step S44 which will be described later if the decision result in the step S42 is NO. On the other hand, if the decision result in the step S42 is YES, a step S43 unpacks (or expands) the packed desired software. For example, the packed desired software is an execute file (EXE file) that has been packed. The step S44 installs the desired software in the personal computer 3 by executing an installing program. A step S45 writes the install information of the desired software in the registry of the personal computer 3. This install information includes the date and time information indicating the date and time when the desired software is installed in the personal computer 3, and includes information in units of seconds and smaller, for example.

A step S46 requests, to the Web server 1, the license key with respect to the desired software, and acquires the license key. A step S47 starts the desired software that has been installed. A step S48 inputs the acquired license key on a license key input screen that is displayed when the desired software is started. A step S49 decides whether or not the input license key is valid, and if the decision result in the step S49 is NO, the process ends and the desired software cannot be used. On the other hand, if the decision result in the step S49 is YES, a step S50 enables the use of the desired software, and the process ends.

The license key is created by the Web server 1 based on the date and time information indicating the date and time when the desired software is installed in the personal computer 3. Accordingly, the step S49 can judge that the license key is valid if date and time information, which is obtained by subjecting the input license key to a reverse process of the predetermined process carried out to create the license key, matches the date and time information that is included in the install information with respect to the desired software written in the registry of the personal computer 3. Once the license key is input to the personal computer 3, it is unnecessary to input the license key to the personal computer 3 again when using the desired software for the second and subsequent times.

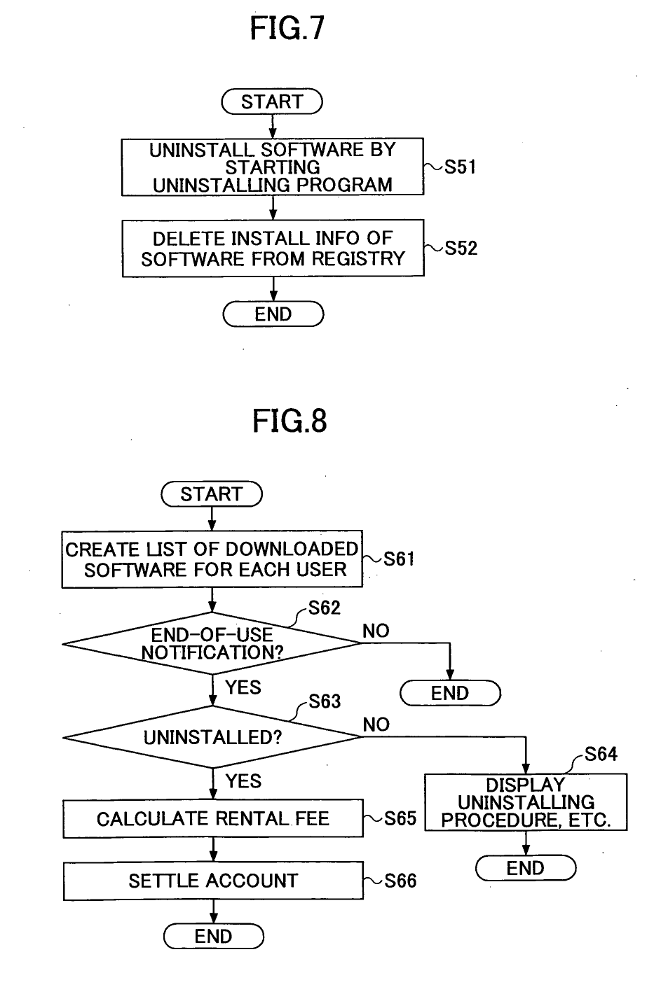

FIG. 7 is a flow chart for explaining a software uninstalling process of the personal computer 3. In FIG. 7, a step S51 starts an uninstalling program to uninstall the desired software. In addition, a step S52 deletes the install information with respect to the desired software, that is written in the registry of the personal computer 3, and the process ends. Hence, the uninstalling of the desired software is carried out in the user-led manner.

FIG. 8 is a flow chart for explaining a software rental ending process, and shows the process of the steps S7 through S9 shown in FIG. 2 in more detail. In FIG. 8, a step S61 creates the list of downloaded software with respect to each user, by referring to the user database stored in the Web serve 1, similarly to the step S21 shown in FIG. 4. As described above, this list of downloaded software includes whether or not the license key with respect to each software is requested, the installed state (state of the registry) and the like. A step S62 decides whether or not an end-of-use notification with respect to the desired software is received from the personal computer, and the process ends if the decision result in the step S62 is NO. The user may make the end-of-use notification with respect to the desired software on the Web page.

On the other hand, if the decision result in the step S62 is YES, a step S63 refers to the list of downloaded software with respect to the user of the personal computer 3, and decides whether or not the desired software has been uninstalled from the personal computer 3. More particularly, a reference is made to the installed state (state of the registry) in the list of downloaded software, and it is judged that the desired software has been uninstalled from the personal computer 3 if the install information with respect to the desired software is not written in the registry of the personal computer 3. If the decision result in the step S63 is NO, a step S64 urges the user to uninstall the desired software by displaying on the personal computer 3 a message indicating that the desired software has not yet been uninstalled, a procedure for uninstalling the desired software and the like, and the process ends.

If the decision result in the step S63 is YES, a step S65 determines the date and time when the uninstalling of the desired software from the personal computer 3 is confirmed as the date when the use of the desired software is ended, that is, the rental end date, and determines the time period of use (used time) of the desired software. The used time of the desired software is determined from the rental start date of the desired software stored in the user database and the rental end date of the desired software, and the step S65 also calculates the rental fee for the desired software depending on the used time of the desired software. A step S66 settles the account by a credit card, for example, based on the calculated rental fee, and the process ends. Of course, the settling of the account is not limited to that using the credit card and any suitable method may be used by the user to pay the rental fee for the desired software.

Next, a description will be given of a second embodiment of the managing apparatus according to the present invention. This second embodiment of the managing apparatus is formed by the Web server 1 shown in FIG. 1, and employs a second embodiment of the managing method according to the present invention. A second embodiment of the managing program according to the present invention is executed by the Web server 1, and may be stored in a second embodiment of the computer-readable storage medium according to the present invention.

In order for the user to open a file in the personal computer, a software (viewer software) that is required to open this file must normally be installed in the personal computer. Hence, the user must know the viewer software that is required to open the file, and it is not easy for the user to handle the file if the user is unfamiliar with the software.

In addition, when using the viewer function, unless the viewer software required to open the file in the personal computer is installed in the personal computer, it is necessary to first convert the file into a format that can be opened by the viewer software which is installed in the personal computer before opening the file or, the user must purchase and install the viewer software that is required to open the file in the personal computer before opening the file. Therefore, the user must perform complicated operations to open the file, and the handling of the file is not easy also from this point of view.

Accordingly, in this second embodiment, the file is opened and displayed on the Web page by use of a viewer software that is acquired from the application server, so as to improve the handling ease of the file.

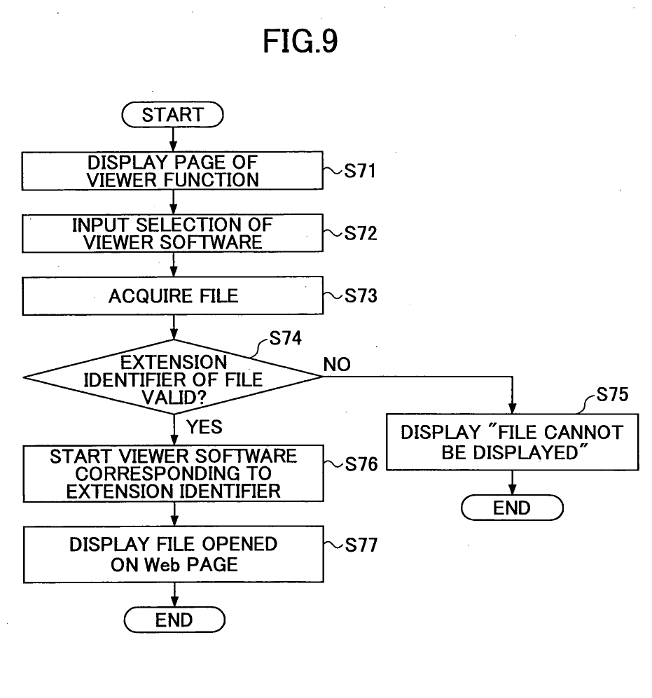

FIG. 9 is a flow chart for explaining a viewer function of this second embodiment. The process shown in FIG. 9 is started when an access is made to a Web page having a viewer function and provided by the Web server 1, from the personal computer 3. The process shown in FIG. 9 is carried out by the Web server 1 shown in FIG. 1.

In FIG. 9, a step S71 displays a Web page (viewer page) having a viewer function on the personal computer 3 in response to an access that is made from the personal computer 3. A step S72 inputs a selection of the viewer software made from the personal computer 3. For example, the user selects the viewer software by selecting on the Web page a file that is to be opened and dragging the selected file to the viewer page. A step S73 acquires the file that is selected when the viewer software is selected.

A step S74 decides whether or not an extension identifier of the acquired file is valid. The application server 2 has a database of viewer software required to open various kinds of files, and if the extension identifier of each file is valid, it indicates that the viewer software required to open the file is stored in the database of the application server 2. If the decision result in the step S74 is NO, the viewer software required to open the file is not stored in the database of the application server 2, and thus, a message such as “File cannot be displayed” is displayed on the personal computer 3 to notify the user that the file cannot be opened, and the process ends.

On the other hand, if the decision result in the step S74 is YES, a step S76 acquires the viewer software corresponding to the extension identifier of the file from the database of the application server 2, and starts the acquired viewer software. A step S77 opens and displays the file on the Web page by using the viewer software that is started, and the process ends. Hence, even if the viewer software required to open the file the user wishes to open is not installed in the personal computer 3, it is possible to refer to the file that is opened on the Web page by the browser, without having to install the viewer software in the personal computer 3.

The service that provides the file as in this second embodiment does not necessarily have to carry out an accounting process. When carrying out the accounting process, it is possible to employ various accounting methods. For example, the service may be provided only with respect to members and the accounting may be fixed with respect to an arbitrary unit of time or, the accounting may be made each time one reference is made to the file.

Of course, the Web server 1 may also be constructed to include the functions of the application server 2 in this second embodiment. In this case, the Web server 1 will include the database, and the application server 2 may be omitted.

This second embodiment may be appropriately combined with the first embodiment described above.

Further, the present invention is not limited to these embodiments, but various variations and modifications may be made without departing from the scope of the present invention.

What is claimed is:

1. A managing apparatus comprising:
a first part configured to transfer data requested by an information processing apparatus to the information processing apparatus;
a second part configured to determine a start date when use of the data is started, based on start date and time information indicating a date and time when the data became usable in the information processing apparatus; and
a third part configured to determine an end date when the use of the data is ended, based on end date and time information indicating a date and time when the data became non-usable in the information processing apparatus.

2. The managing apparatus as claimed in claim 1, wherein the first part sends the data to the information processing apparatus from a Web page that is provided by the managing apparatus.

3. The managing apparatus as claimed in claim 1, wherein the second part obtains the start date and time information from date and time information indicating a date and time when the information processing apparatus stored the data.

4. The managing apparatus as claimed in claim 1, wherein the third part obtains the end date and time information from date and time information indicating a date and time when an end-of-use notification with respect to the data is received from the information processing apparatus.

5. The managing apparatus as claimed in claim 4, wherein the third part obtains the start date and time information from date and time information indicating a date and time when the data is installed in the information processing apparatus, and obtains the end date and time information from date and time information indicating a date and time when the data is uninstalled from the information processing apparatus.

6. The managing apparatus as claimed in claim 1, further comprising:
a fourth part configured to calculate a rental fee with respect to the data, based on the start date and time information and the end date and time information with respect to the data.

7. A managing method comprising:
a first step transferring data requested by an information processing apparatus to the information processing apparatus;
a second step determining a start date when use of the data is started, based on start date and time information indicating a date and time when the data became usable in the information processing apparatus; and
a third step determining an end date when the use of the data is ended, based on end date and time information indicating a date and time when the data became non-usable in the information processing apparatus.

8. The managing method as claimed in claim 7, wherein the first step sends the data to the information processing apparatus from a Web page that is provided by a managing apparatus.

9. The managing method as claimed in claim 7, wherein the second step obtains the start date and time information from date and time information indicating a date and time when the information processing apparatus stored the data.

10. The managing method as claimed in claim 7, wherein the third step obtains the end date and time information from date and time information indicating a date and time when an end-of-use notification with respect to the data is received from the information processing apparatus.

11. The managing method as claimed in claim 10, wherein the third step obtains the start date and time information from date and time information indicating a date and time when the data is installed in the information processing apparatus, and obtains the end date and time information from date and time information indicating a date and time when the data is uninstalled from the information processing apparatus.

12. The managing method as claimed in claim 7, further comprising:
a fourth step calculating a rental fee with respect to the data, based on the start date and time information and the end date and time information with respect to the data.

13. A computer-readable storage medium which stores a managing program for causing a computer to carry out a management, said managing program comprising:
a first procedure causing the computer to transfer data requested by an information processing apparatus to the information processing apparatus;
a second procedure causing the computer to determine a start date when use of the data is started, based on start date and time information indicating a date and time when the data became usable in the information processing apparatus; and
a third procedure causing the computer to determine an end date when the use of the data is ended, based on end date and time information indicating a date and time when the data became non-usable in the information processing apparatus.

14. The computer-readable storage medium as claimed in claim 13, wherein the first procedure causes the computer to send the data to the information processing apparatus from a Web page that is provided by the computer.

15. The computer-readable storage medium as claimed in claim 13, wherein the second procedure causes the computer to obtain the start date and time information from date and time information indicating a date and time when the information processing apparatus stored the data.

16. The computer-readable storage medium as claimed in claim 13, wherein the third procedure causes the computer to obtain the end date and time information from date and time information indicating a date and time when an end-of-use notification with respect to the data is received from the information processing apparatus.

17. The computer-readable storage medium as claimed in claim 16, wherein the third procedure causes the computer to obtain the start date and time information from date and time information indicating a date and time when the data is installed in the information processing apparatus, and obtains the end date and time information from date and time information indicating a date and time when the data is uninstalled from the information processing apparatus.

18. The computer-readable storage medium as claimed in claim 13, further comprising:
a fourth procedure causing the computer to calculate a rental fee with respect to the data, based on the start date and time information and the end date and time information with respect to the data.
